(19) United States
(12) Patent Application Publication
(10) Pub. No.: US 2004/0127379 A1
(43) Pub. Date: Jul. 1, 2004

(54) Thermally labile bleaching composition

(75) Inventor: Stephen Norman Batchelor, Bebington (GB)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/665,229

(22) Filed: Sep. 17, 2003

(30) Foreign Application Priority Data
Sep. 24, 2002 (GB) 0222105.9

(51) Int. Cl. C11D 7/18

(52) U.S. Cl. 510/302

(57) ABSTRACT

The present invention provides a bleaching composition comprising a thermally labile peroxide. The application of heat, for example by ironing, of a textile stain induces bleaching providing the user instant gratification. The bleaching composition may also comprise a conventional laundry peroxide and bleach precursor.

### TECHNICAL FIELD

The present invention relates to bleaching compositions and more particularly to bleaching compositions suitable for use in fabric laundry.

### BACKGROUND OF THE INVENTION

Traditional washing products use hydrogen peroxide as a primary oxidant bleach. The performance may be enhanced by addition of bleach activators, which form percarboxylic acids, or by the addition of transition metal compounds.

Procter and Gamble's U.S. Pat. No. 4,154,695 issued 15 May 1979 discloses bleaching and detergent compositions containing a diacyl peroxide of general formula ROOR1 in which R represents a phthaloyl radical and R1 a moiety such that ROOR1, ROOR and R1OOR1 are all soluble in mildly alkaline aqueous solutions. The compositions, optionally containing a persalt such as sodium perborate. The diacyl peroxide compositions are also taught as desensitised to impact or abrasion.

Procter and Gamble's WO 93/07086, filed 2 Oct. 1991, discloses a bleaching composition for bleaching of stained articles, comprising a urea clathrate of a diacyl or tetraacyl peroxide, e.g. dinonanoylperoxide, dioctanoyl peroxide or diperoxyazelaic diacetate. The composition may also comprise a compound capable of yielding hydrogen peroxide in an aqueous medium, e.g., sodium perborate.

Procter and Gamble's WO 98/11189, filed 13 Sep. 1996, discloses a process for pre-treating coloured fabrics with a liquid composition comprising a C6 to C20 aliphatic diacyl peroxide before washing fabrics. Also disclosed are liquid compositions for pre-treating fabrics, having a pH of from 0 to 6.

Procter and Gamble's WO 00/27990, filed 10 Nov. 1999, discloses the use of diacyl peroxides in laundry. The diacyl peroxides disclosed may be selected from the group consisting of dialiphatic peroxide, diaromatic peroxide, aliphatic-aromatic peroxide or mixtures thereof. The diacyl peroxides disclosed are provided in a composition in the form of an aqueous emulsion together with a surfactant.

### SUMMARY OF INVENTION

The prior art lacks suitable heat responsive systems for bleaching stains. There is also an on-going need for new bleaches to give superior bleach performance from fabric laundry products over a wide range of conditions.

In contrast to the prior art the labile organic peroxides of the present invention function via a radical mechanism rather than oxygen atom transfer and are able to bleach carotenoid stains at lower concentration levels and temperatures than those prescribed in the prior art. The present invention provides a system that bleaches during an ironing process. In this regard, the user is provided with instant gratification and associates the product with its effect. Such a consumer cue provides an important competitor advantage.

The phrase “labile organic peroxide” is used to differentiate from conventional peroxides and sources thereof as described in the section found herein entitled “Peroxygen Bleach or Source Thereof”.

The present invention provides a bleaching composition comprising: (a) a labile organic peroxide in the range from 0.001 wt % to 5.0 wt %, wherein said labile organic peroxide is selected from the group consisting of: ketone peroxides, perketals, peresters and peroxydicarbonates; and, (b) the balance carriers and adjunct ingredients.

A preferred class of labile organic peroxides is that of ketone peroxides, in particular alkyl ketone peroxides. Preferably the labile organic peroxide is present in the range from 0.05 wt % to 1.0 wt %.

Because the labile organic peroxides are thermally labile they exhibit anti-dye transfer properties in the wash at high temperatures where the problem of dye transfer is most acute. Anti-dye problems are particularly problematic in Europe where high wash temperatures are found. The present invention also extends to a method of anti-dye transfer.

The present invention also extends to a method of bleaching a fabric stain, the method comprising the steps of contacting the fabric stain with the bleaching composition and subsequently subjecting the fabric stain to a warming step such that the stain reaches a temperature of at least 40° C., preferably 60° C. The warming step provides after bleaching and such a step may be provided, for example, by a tumble drier, ironing process or any other heat-generating process wherein the bleaching effect is accelerated in comparison to drying at ambient temperatures. Sun drying may provide the heat required and contribute to the liability of the labile organic peroxide by photo-cleavage of the labile organic peroxide. However, it is preferred that the bleaching process is conducted in a thermal manner.

The present invention may also be used in the form of a pre-wash or post-wash treatment. Suitable treatment means for application to a textile material include sprays, pens, roller-ball devices, bars, soft solid applicator sticks and impregnated cloths or cloths containing microcapsules. Such means are well known in the analogous art of deodorant application and/or in spot treatment of textiles. The bleaching composition may be applied using tapes, sheets or sticking plasters coated or impregnated with the substance, or containing microcapsules of the substance. The bleaching composition may for example be incorporated into a drier sheet so as to be activated or released during a tumble-drier cycle, or the substance can be provided in an impregnated or microcapsule-containing sheet so as to be delivered to the textile when ironed.

The present invention also extends to a commercial package comprising the bleaching composition of the present invention together with instructions for its use.

### DETAILED DESCRIPTION

The labile organic peroxide is of the following type: ketone peroxide, perketal, perester and peroxydicarbonate. Preferably labile organic peroxide is aliphatic and devoid of aromatic groups. The labile organic peroxides are commercially available or may be easily synthesised. Labile organic peroxides listed below are sold by Degussa: http://www.degussa-initiators.com/en/pro/index.html the address of their and subsidiary and address is Peroxid-Chemie GmbH & Co.KG, Dr.-Gustav-Adolph-Str.3, 82049, Pullach Germany. Alternatively, these labile organic peroxides may be generated in situ during the wash.

There are many texts dealing with the properties and synthesis of organic peroxides, and the reader is directed to both: Houben-Weyl, Methoden der Organischen Chemie, Vol. E3, Parts 1 and 2, Georg Thieme, Stuttgart, 1988 and Organic Peroxides, Ed. D. Swern, Vols. 1, 2, and 3, Wiley-Interscience, New York, 1971 and references found therein. THE READER IS ALERTED TO THE EXPLOSIVE NATURE OF SOME PEROXIDES, CAUTION SHOULD BE OBSERVED IN THEIR HANDLING AND PREPARATION.

Ketone Peroxides

Ketone peroxides are readily formed by reacting a ketone with hydrogen peroxide in an acidic medium. The following equation illustrates the formation of a ketone peroxide and the term ketone peroxide as used herein extends to the dimers, trimers and further oligimers that may be formed.

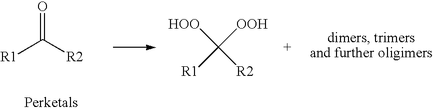

Perketals are generally of the form illustrated below.

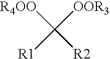

Peresters

Peresters are generally of the form illustrated below.

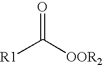

One type of perester that may be employed are those derived from oxalyl chloride [ClC(O)C(O)Cl] and a hydroperoxide.

Peroxy Dicarbonates

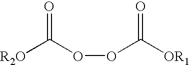

The non-exhaustive list of compounds given below are sold by Degussa and may be use as a labile organic peroxide in the present invention.

(1) Ketone Peroxides

acetyl acetone peroxide

methyl ethyl ketone peroxide

cyclohexanone peroxide

methyl isobutyl ketone peroxide

(2) Perketals

2,2-Di-(tert-butylperoxy)-butane

1,1-Di-(tert-butylperoxy)-cyclohexane

1,1-Bis(tert-butylperoxy)3,3,5-trimethyl cyclohexane

(3) Peresters

Cumylperoxy neodecanoate

1,3-Di(2-neodecanoylperoxy isopropyl)benzene

tert-Amylperoxy-2-ethyl hexanoate

tert-Amylperoxy-2-ethyl hexyl carbonate

tert-Amylperoxy neodecanoate

tert-Amylperoxy pivalate

tert-Butylperoxy acetate

tert-Butylperoxy benzoate

tert-Butylperoxy-2-ethyl hexanoate

tert-Butylperoxy-2-ethyl hexyl carbonate

tert-Butylperoxy isopropyl carbonate

tert-Butylperoxy-3,5,5-trimethyl hexanoate

tert-Butylperoxy neodecanoate

tert-Butylperoxy pivalate

(4) Peroxy Dicarbonates

Di-(4-tert-butyl cyclohexyl)-peroxydicarbonate

Dicetylperoxy dicarbonate

Di-cyclohexyl peroxydicarbonate

Di-(2-ethyl hexyl)-peroxydicarbonate

Dimyristylperoxy dicarbonate

Di-(sec-butyl)-peroxydicarbonate

The labile peroxide is not a diacyl peroxide. Diacyl peroxides are of the form:

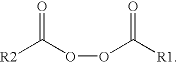

In contrast to the peroxydicarbonates the carbonyls of the central C(O)OOC(O) in a diacyl peroxide are bound to carbon atoms and not oxygen.

Balance Carriers and Adjunct Ingredients

The bleaching composition preferably comprises other materials such as detergents/surfactants, fillers, builders (e.g., zeolites and/or sodium carbonate), and enzymes. Transition metal sequestrants such as EDTA, and phosphonic acid derivatives such as EDTMP (ethylene diamine tetra(methylene phosphonate)) may also be included, for example to improve the stability sensitive ingredients such as enzymes, fluorescent agents and perfumes, but provided the composition remains bleaching effective. If required other bleach actives may be present such as other peroxygen species and activators. These balance carriers and adjunct ingredients preferably make up the bulk of the bleaching composition to 100% but do not exclude the presence of other minor ingredients.

The Detergent Composition

The labile organic peroxide may be used in a detergent composition specifically suited for stain bleaching purposes, and this constitutes a second aspect of the invention. In this regard, it is preferred that the bleaching composition comprises from 0.5 wt % to 50 wt % of a surfactant, preferably 5 wt % to 20 wt %.

This surfactant system may in turn comprise 0 to 95% by weight of one or more anionic surfactants and 5 to 100% by weight of one or more nonionic surfactants. The surfactant system may additionally contain amphoteric or zwitterionic detergent compounds, but this in not normally desired owing to their relatively high cost.

In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates and sodium C₁₂-C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials in particular the groups and examples of anionic and nonionic surfactants pointed out in EP-A-346 995 (Unilever). Especially preferred is surfactant system that is a mixture of an alkali metal salt of a C₁₆-C₁₈ primary alcohol sulphate together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

The detergent composition may take any suitable physical form, such as a powder, granular composition, tablets, a paste or an anhydrous gel.

Peroxygen Bleach or Source Thereof

The bleaching composition of the present invention may also comprise other peroxy bleaching species which are distinct and additional to the labile organic peroxide. The peroxy bleaching species may be a compound that is capable of yielding hydrogen peroxide in aqueous solution. Hydrogen peroxide sources are well known in the art. They include the alkali metal peroxides, organic peroxides such as urea peroxide, and inorganic persalts, such as the alkali metal perborates, percarbonates, perphosphates persilicates and persulphates. Mixtures of two or more such compounds may also be suitable.

Particularly preferred are sodium perborate tetrahydrate and, especially, sodium perborate monohydrate. Sodium perborate monohydrate is preferred because of its high active oxygen content. Sodium percarbonate may also be preferred for environmental reasons. The amount thereof in the composition of the invention usually will be within the range of about 0.1 to 25 wt %, preferably from 4 to 25 wt %. One skilled in the art will appreciate that these amounts may be reduced in the presence of a bleach precursor e.g., N,N,N′N′-tetraacetyl ethylene diamine (TAED).

When the labile organic peroxide is present alone without a peroxygen bleach or source Thereof the pH of the wash liquor is not important however when a peroxygen bleach or source thereof is present is preferred that the wash liquor is alkaline, i.e., in the range 7 to 11.

Another suitable hydrogen peroxide generating system is a combination of a C1-C4 alkanol oxidase and a C1-C4 alkanol, especially a combination of methanol oxidase (MOX) and ethanol. Such combinations are disclosed in International Application PCT/EP 94/03003 (Unilever), which is incorporated herein by reference.

Alkylhydroxy peroxides are another class of peroxy bleaching compounds. Examples of these materials include cumene hydroperoxide and t-butyl hydroperoxide.

Organic peroxyacids may also be suitable as the peroxy bleaching compound. Such materials normally have the general formula:

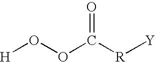

wherein R is an alkylene or substituted alkylene group containing from 1 to about 20 carbon atoms, optionally having an internal amide linkage; or a phenylene or substituted phenylene group; and Y is hydrogen, halogen, alkyl, aryl, an imido-aromatic or non-aromatic group, a COOH or

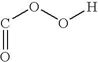

group or a quaternary ammonium group.

Typical monoperoxy acids useful herein include, for example:

(i) peroxybenzoic acid and ring-substituted peroxybenzoic acids, e.g. peroxy-.alpha.-naphthoic acid;

(ii) aliphatic, substituted aliphatic and arylalkyl monoperoxyacids, e.g. peroxylauric acid, peroxystearic acid and N,N-phthaloylaminoperoxy caproic acid (PAP); and

(iii) 6-octylamino-6-oxo-peroxyhexanoic acid.

Typical diperoxyacids useful herein include, for example:

(iv) 1,12-diperoxydodecanedioic acid (DPDA);

(v) 1,9-diperoxyazelaic acid;

(vi) diperoxybrassilic acid; diperoxysebasic acid and diperoxyisophthalic acid;

(vii) 2-decyldiperoxybutane-1,4-diotic acid; and

(viii) 4,4′-sulphonylbisperoxybenzoic acid.

Also inorganic peroxyacid compounds are suitable, such as for example potassium monopersulphate (MPS). If organic or inorganic peroxyacids are used as the peroxygen compound, the amount thereof will normally be within the range of about 2-10% by weight, preferably from 4-8% by weight.

Peroxyacid bleach precursors are known and amply described in literature, such as in the British Patents 836988; 864,798; 907,356; 1,003,310 and 1,519,351; German Patent 3,337,921; EP-A-0185522; EP-A-0174132; EP-A-0120591; and U.S. Pat. Nos. 1,246,339; 3,332,882; 4,128,494; 4,412,934 and 4,675,393.

Another useful class of peroxyacid bleach precursors is that of the cationic i.e. quaternary ammonium substituted peroxyacid precursors as disclosed in U.S. Pat. Nos. 4,751,015 and 4,397,757, in EP-A0284292 and EP-A-331,229. Examples of peroxyacid bleach precursors of this class are:

2-(N,N,N-trimethyl ammonium) ethyl sodium-4-sulphonphenyl carbonate chloride (SPCC);

N-octyl-N,N-dimethyl-N10-carbophenoxy decyl ammonium chloride (ODC);

3-(N,N,N-trimethyl ammonium) propyl sodium-4-sulphophenyl carboxylate; and

N,N,N-trimethyl ammonium toluyloxy benzene sulphonate. A further special class of bleach precursors is formed by the cationic nitriles as disclosed in EP-A-303,520 and in European Patent Specification No.'s 458,396 and 464,880.

Any one of these peroxyacid bleach precursors can be used in the present invention, though some may be more preferred than others.

Of the above classes of bleach precursors, the preferred classes are the esters, including acyl phenol sulphonates and acyl alkyl phenol sulphonates; the acyl-amides; and the quaternary ammonium substituted peroxyacid precursors including the cationic nitrites.

Examples of said preferred peroxyacid bleach precursors or activators are sodium-4-benzoyloxy benzene sulphonate (SBOBS); N,N,N′N′-tetraacetyl ethylene diamine (TAED); sodium-1-methyl-2-benzoyloxy benzene-4-sulphonate; sodium-4-methyl-3-benzoloxy benzoate; SPCC; trimethyl ammonium toluyloxy-benzene sulphonate; sodium nonanoyloxybenzene sulphonate (SNOBS); sodium 3,5,5-trimethyl hexanoyl-oxybenzene sulphonate (STHOBS); and the substituted cationic nitrites.

Other classes of bleach precursors for use with the present invention are found in WO0015750, for example 6-(nonanamidocaproyl)oxybenzene sulphonate.

The precursors may be used in an amount of up to 12%, preferably from 2-10% by weight, of the composition.

Enzymes

The detergent compositions of the present invention may additionally comprise one or more enzymes, which provide cleaning performance, fabric care and/or sanitation benefits.

Said enzymes include oxidoreductases, transferases, hydrolases, lyases, isomerases and ligases. Suitable members of these enzyme classes are described in Enzyme nomenclature 1992: recommendations of the Nomenclature Committee of the International Union of Biochemistry and Molecular Biology on the nomenclature and classification of enzymes, 1992, ISBN 0-12-227165-3, Academic Press.

Examples of the hydrolases are carboxylic ester hydrolase, thiolester hydrolase, phosphoric monoester hydrolase, and phosphoric diester hydrolase which act on the ester bond; glycosidase which acts on O-glycosyl compounds; glycosylase hydrolysing N-glycosyl compounds; thioether hydrolase which acts on the ether bond; and exopeptidases and endopeptidases which act on the peptide bond. Preferable among them are carboxylic ester hydrolase, glycosidase and exo- and endopeptidases. Specific examples of suitable hydrolases include (1) exopeptidases such as aminopeptidase and carboxypeptidase A and B and endopeptidases such as pepsin, pepsin B, chymosin, trypsin, chymotrypsin, elastase, enteropeptidase, cathepsin B, papain, chymopapain, ficain, thrombin, plasmin, renin, subtilisin, aspergillopepsin, collagenase, clostripain, kallikrein, gastricsin, cathepsin D, bromelain, chymotrypsin C, urokinase, cucumisin, oryzin, proteinase K, thermomycolin, thermitase, lactocepin, thermolysin, bacillolysin. Preferred among them is subtilisin; (2) glycosidases such as α-amylase, β-amylase, glucoamylase, isoamylase, cellulase, endo-1,3(4)-β-glucanase (β-glucanase), xylanase, dextranase, polygalacturonase (pectinase), lysozyme, invertase, hyaluronidase, pullulanase, neopullulanase, chitinase, arabinosidase, exocellobiohydrolase, hexosaminidase, mycodextranase, endo-1,4-β-mannanase (hemicellulase), xyloglucanase, endo-β-galactosidase (keratanase), mannanase and other saccharide gum degrading enzymes as described in WO-A-99/09127. Preferred among them are a-amylase and cellulase; (3) carboxylic ester hydrolase including carboxylesterase, lipase, phospholipase, pectinesterase, cholesterol esterase, chlorophyllase, tannase and wax-ester hydrolase. Preferred among them is lipase.

Examples of transferases and ligases are glutathione S-transferase and acid-thiol ligase as described in WO-A-98/59028 and xyloglycan endotransglycosylase as described in WO-A-98/38288.

Examples of lyases are hyaluronate lyase, pectate lyase, chondroitinase, pectin lyase, alginase II. Especially preferred is pectolyase, which is a mixture of pectinase and pectin lyase.

Examples of the oxidoreductases are oxidases such as glucose oxidase, methanol oxidase, bilirubin oxidase, catechol oxidase, laccase, peroxidases such as ligninase and those described in WO-A-97/31090, monooxygenase, dioxygenase such as lipoxygenase and other oxygenases as described in WO-A-99/02632, WO-A-99/02638, WO-A-99/02639 and the cytochrome based enzymatic bleaching systems described in WO-A-99/02641.

The activity of oxidoreductases, in particular the phenol oxidising enzymes in a process for bleaching stains on fabrics and/or dyes in solution and/or antimicrobial treatment can be enhanced by adding certain organic compounds, called enhancers. Examples of enhancers are 2,2′-azo-bis-(3-ethylbenzo-thiazoline-6-sulphonate (ABTS) and Phenothiazine-10-propionate (PTP). More enhancers are described in WO-A-94/12619, WO-A-94/12620 , WO-A-94/12621, WO-A-97/11217, WO-A-99/23887. Enhancers are generally added at a level of 0.01% to 5% by weight of detergent composition.

Builders, polymers and other enzymes as optional ingredients may also be present as found in WO0060045.

Suitable detergency builders as optional ingredients may also be present as found in WO0034427.

The invention will now be further illustrated by way of the following non-limiting examples:

### EXAMPLE 1

Two separate stains on white woven cotton cloth (1.3 g piece cotton per stain) were created as follows:

(a) A 0.05% weight solution of β-carotene in extra virgin olive oil was prepared. Four drops of the β-carotene/extra virgin olive oil solution was pipetted onto a cloth sample.

(b) A saturated solution of the spice turmeric was made in soya oil. Four drops of the spice turmeric/soya oil solution was pipetted onto a cloth sample.

Two model wash solution were created as follows:

(c) 0.6 g Neodol™ 25-7 (ex Shell, a non-ionic EO7 ionic surfactant), 0.0017 g Dequest™ 204 series (ex Monsanto a metal ion sequesterent, 150 g of water

(d) as (c) but with 0.2 g of Methyl isobutyl ketone peroxide (MIKP-NA-1™ ex degussa) added.

To each wash solution two of the β-carotene, two of the turmeric stained cloths and a white cloth (white ballast) were added. The solutions were heated to 70° C. and agitated for 30 minutes, then the cloths rinsed in cold water, wrung and dried in a tumble dryer. The residual staining on the cloth was then measured on a reflectance spectrometer and expressed as the ΔE value relative to a clean white piece of cotton. The results are given in Table 1.

TABLE 1
Wash results with methyl isobutyl ketone peroxide.

| | | (d) methyl |
|---|---|---|
| | | isobutyl ketone |
| | (c) control/ΔE | peroxide/ΔE |
| (a) β-carotene | 29.7 | 20.2 |
| (b) Turmeric | 40.6 | 43.1 |
| White ballast | 15.2 | 6.1 |

In the control wash large residual staining and significant stain transfer to the white ballast is observed. Washing with a detergent composition containing methyl isobutyl ketone peroxide bleaches the β-carotene stain and reduces the stain transfer to the white ballast cloth.

### EXAMPLE 2

Two separate stains on white woven cotton (1.0 g piece cotton per stain) were created as follows:

(a) A 0.1% weight solution of β-carotene in extra virgin olive oil was made. One drop of the β-carotene/virgin olive oil solution was pipetted onto the cloth

(b) A saturated solution of the spice turmeric was made in sunflower oil. One drop of spice turmeric/sunflower oil was pipetted onto the cloth.

The stains were aged for one day in the dark.

Two model washing liquids were created as follows:

(c) 10% sodium LAS in water

(d) as (c) but with 0.38% Methyl isobutyl ketone peroxide

Two of each of the stains plus a white ballast cloth were washed in 90 ml of water and 10 ml of the washing liquids at 65° C. for 30 minutes, rinsed in cold water, wrung and dried in a tumble dryer. The residual staining on the cloth was then measured on a reflectance spectrometer and expressed as the ΔE value relative to a clean white piece of cotton. The average results are given in Table 2.

TABLE 2
Wash results with methyl isobutyl ketone peroxide.

| | | (d) methyl |
|---|---|---|
| | | isobutyl ketone |
| | (c) control/ΔE | peroxide/ΔE |
| (a) β-carotene | 27.2 | 24.0 |
| (b) Turmeric | 22.4 | 19.3 |
| White ballast | 1.1 | 0.7 |

In the control wash large residual staining and significant stain transfer to the white ballast is observed. Washing with methyl isobutyl ketone peroxide bleaches both stains and reduces the stain transfer to the white ballast cloth.

### EXAMPLE 3

The clothes from Example 2 were briefly ironed (iron on cotton setting) and the stains remeasured, Table 3. Ironing was found to increase the stain removal benefit of the ketone peroxide containing wash (d).

TABLE 3
Effect of ironing.

| | | (d) methyl |
|---|---|---|
| | | isobutyl ketone |
| | (c) control/ΔE | peroxide/ΔE |
| (a) β-carotene | 26.9 | 22.3 |
| (b) Turmeric | 21.1 | 17.5 |

### EXAMPLE 4

A β-carotene stain was created as per Example 2. The cloth was place in 100 ml water at 25° C. that contained 0.12 g of methyl isobutyl ketone peroxide for 20 minutes. After this the cloth was removed, excess water removed and then ironed dried (iron on cotton setting). Before ironing a deep orange stain was visible on the cloth, after ironing the stain had disappeared and the measured ΔE of the cloth was 3.4. When similar stains were washed in surfactants and ironed dried no iron-induced bleaching was observed (vide supra). Thus use of methyl isobutyl ketone peroxide gave good iron-induced bleaching.

### EXAMPLE 5

Red stains was created by placing 2 drops of a 0.1% solution of β-carotene in olive oil on to woven cotton squared weighing 1.7 g. The stains were aged for 1 hours then washed in water solution containing various amounts of methyl isobutyl ketone peroxide. Washes took 30 minutes, were conducted at 25° C. with a liquor to cloth ratio of 30:1. The stains were then rinsed, each ironed for 60 seconds using a conventional electric iron set on cotton, and the residual staining measured on a reflectance spectrometer and expressed as the ΔE value relative to a clean white piece of cotton. The results are given in Table 1.

TABLE 4
Bleach result with different levels
methyl isobutyl ketone peroxide.

| Level of methyl isobutyl | Residual |
|---|---|
| ketone peroxide/ppm | stain/ΔE |
| 0 | 34.8 |
| 17 | 24.3 |
| 34 | 17.7 |
| 170 | 8.3 |

Clear benefits are seen from addition of the ketone peroxide and increase with concentration.

### EXAMPLE 6

Stains were created as described in Example 5. The stains were washed in water containing 4 g/l of Wisk™ washing liquids (ex Lever Bros USA, it contains anionic and nonionic surfactants, enzymes, sodium citrate, stabilizer, buffering agent, polymer, perfume, optical brightener and colourants) with various quantities of methyl isobutyl ketone peroxide added. Washes were conducted in an analogous manner to Example 5 (i.e., wash, iron dry measure.). The results are shown in Table 5.

TABLE 5
Benefits observed with WISK ™ containing the ketone peroxide

| % methyl isobutyl ketone | Residual |
|---|---|
| peroxide in WISK | stain/ΔE |
| 0 | 21.3 |
| 0.085 | 19.4 |
| 0.34 | 13.1 |
| 0.68 | 9.1 |

Clear bleach benefits are seen from adding methyl isobutyl ketone peroxide.

### EXAMPLE 7

Stains were created as described in Example 5. The stains were washed in water containing 2 g/l of OMO Multi Acao™ washing powder (ex Gessy Lever Brazil) and 7 g/l of Persil™ Colour Care biological (ex Lever Bros UK) with and without the addition of 0.34 g/l methyl isobutyl ketone peroxide. Washes were conducted in an analogous manner to example 5 (i.e., wash, iron dry measure.). The results are shown in Table 6.

TABLE 6
Benefits observed with OMO Multi Acao ™ and Persil ™ Colour
Care biological containing the ketone peroxide

| | Residual |
|---|---|
| Wash condition | stain, ΔE |
| OMO | 21.1 |
| OMO + ketone peroxide | 4.5 |
| Persil | 26 |
| Persil + ketone peroxide | 6.9 |

Clear bleach benefits are seen from adding methyl isobutyl ketone peroxide. The lower values for OMO is due to the presence of fluorescer in this formulation. Both washing powders give a solution pH of 10 to 11. OMO is an anionic/cationic, phosphate based powder and Persil an anionic/non-ionic zeolite based powder. Hence the technology performs in a wide variety of modern commerical wash formulations.

### EXAMPLE 8

Stains were created as described in Example 5, but using a sunflower oil solution. In addition a turmeric stain was created by dripping 3 drops of a saturated turmeric solution in sunflower oil onto cotton. 4 wash loads were created by taking 2 pieces of the β-carotene stained cotton, 1 piece of the turmeric stained cotton and a piece of cotton dyed with sulphur green. The total weight of cotton was 6 g and this was washed in 180 ml of 40° C. water with 1 g of Persil Colour and the following peroxides added:

(a) none

(b) 100 ppm benzoyl peroxide (added from an ethanolic solution)

(c) 150 ppm peracetic acid (from a water solution)

(d) 100 ppm methyl isobutyl ketone peroxide (neat) Following the 15 minutes wash the stains were rinsed 4 times then ironed dried and the Residual stain, ΔE measured and the damage to the dyed green cloth (ΔE for green cloth measured to undamaged original). The results are given in Table 7.

TABLE 7
Benefits and dye damage observed with different peroxides.

| | Green/AE | β-carotene/ΔE | turmuric/ΔE |
|---|---|---|---|
| None | 6.9 | 25.2 | 24.7 |
| Benzoyl | 11.7 | 20.5 | 17.8 |
| peroxide | | | |
| Peracetic | 17.0 | 24.8 | 29.1 |
| acid | | | |
| Ketone | 11.0 | 13.1 | 25.2 |
| peroxide | | | |

From the Table 7 it is clear that the ketone peroxide gives the best removal of the β-carotene stain and the lowest dye damage.

1. A bleaching composition comprising:
(a) a labile organic peroxide in the range from 0.001 wt % to 5.0 wt %, wherein said labile organic peroxide is selected from the group consisting of: ketone peroxides, perketals, peresters and peroxydicarbonates; and,
(b) the balance carriers and adjunct ingredients.

2. A bleaching composition according to claim 1, wherein the labile organic peroxide is present in the range from 0.05 wt % to 1.0 wt %.

3. A bleaching composition according to claim 1, wherein the labile organic peroxide is a ketone peroxide.

4. A bleaching composition according to claim 3, wherein the ketone peroxide is an alkyl ketone peroxide.

5. A bleaching composition according claim 1, wherein the bleaching composition comprises a another peroxide in the range of 0.1 to 25 % wt selected from the group consisting of: inorganic peroxides, inorganic persulphates and organic peracids.

6. A bleaching composition according to claim 5, wherein the peroxide is selected from the sodium percarbonate and sodium perborate.

7. A bleaching composition according to claim 5 or 6, wherein the bleaching composition comprises a bleach activator.

8. A bleaching composition according to claim 7, wherein the bleaching composition comprises N,N,N′N′-tetraacetyl ethylene diamine.

9. A bleaching composition according to claim 1, wherein the bleaching composition comprises a surfactant in the range from 0.5 wt % to 50 wt %.

10. A bleaching composition according to claim 9, wherein the bleaching composition comprises a surfactant in the range from 5 wt % to 20 wt %.

11. A bleaching composition according to claim 1, wherein the bleaching composition comprises an enzyme.

12. A bleaching composition according to claim 1, wherein the bleaching composition comprises a builder.

13. Use of the bleaching composition as defined in claim 1 for bleaching a textile stain.

14. A liquor comprising the bleaching composition as defined in claim 1.

15. A liquor according to claim 14, wherein the liquor is an aqueous liquor.

16. A liquor according to claim 14, wherein the liquor is a non-aqueous.
